(19) United States
(12) Patent Application Publication
(10) Pub. No.: US 2004/0050420 A1
(43) Pub. Date: Mar. 18, 2004

(54) Method for detecting solvent leakage during manufacture of a semiconductor device

(75) Inventors: Chain-Chi Huang, Hsinchu (TW); Hsin-Hung Chien, Hsinchu (TW); Chung-Jen Chu, Hsinchu (TW); Ching-Hua Cho, Hsinchu (TW)

Correspondence Address: Finnegan, Henderson, Farabow,, Garrett & Dunner, L.L.P., 1300 I Street, N.W., Washington, DC, 20005-3315, US

(73) Assignee: Macronix International Co., Ltd.

(21) Appl. No.: 10/241,486

(22) Filed: Sep. 12, 2002

(51) Int. Cl. G01M 3/04

(52) U.S. Cl. 137/312

(57) ABSTRACT

A device for detecting leakage of a chemical solvent from a tool for manufacturing a semiconductor device that includes a control box for receiving at least one input signal, including a front panel having a first indicator capable of providing an alert for chemical solvent leakage, and a circuit board for receiving the at least one input signal and triggering the alert, a tray configured for collecting the leaked chemical solvent, including a plurality of substantially vertical sides, and a plurality of legs, at least one of which being adjustable to render a corner of the tray closer to ground relative to other corners of the tray, and a sensor provided at a position relative to the tray for detecting chemical solvent leakage and providing the input signal to the control box.

### FIELD OF THE INVENTION

This invention pertains in general to an apparatus for detecting liquid leakage and, more particularly, to an apparatus for detecting leakage of solvent used in the manufacturing process of a semiconductor product.

### BACKGROUND

In the semiconductor manufacturing process, a plurality of integrated circuits (“ICs”) are formed on a silicon wafer through a number of deposition and etching steps. For example, a machine known as a “stepper” is used at various stages of the manufacturing process to transfer circuit layout patterns onto a layer by exposing a photoresist to ultraviolet light through a mask, or reticle. These patterns are formed in the layer beneath the photoresist through an etching process, a process by which material is removed from a silicon substrate and/or thin films provided on the substrate by chemical reaction. A mask, or a photoresist, is used to protect specific regions of the substrate or thin film surface by removing the material not covered by the mask or photoresist.

Generally, there are two etching techniques, dry etch and wet etch, to transfer the desired patterns onto a layer. A dry etch, for example, Reactive Ion Etch (“RIE”), generally uses high-energy plasma ions to bombard portions of a designated layer for the purpose of removing certain portions of the designated layer. A wet etch, in contrast, employs various types of corrosive chemical solvents to remove designated portions of a layer. The wet etch process is also used throughout the entire semiconductor manufacturing process to remove, shape, and clean various portions of the conducting, semiconducting, and dielectric layers provided over the silicon wafer during the manufacturing process.

The chemical solvents used in the wet etch processes are highly corrosive, and an example of which is the hydro-fluoride (HF) solution. Should there be a leak, these high-corrosive chemical solvents pose a threat not only to the integrity of the “clean room” environment in the semiconductor manufacturing facility, or “fab,” but also to the physical safety of the operators working inside the fab.

Therefore, there is a need for an apparatus to detect such chemical solvent leakage.

### SUMMARY OF THE INVENTION

In accordance with the invention, there is provided a device for detecting leakage of a chemical solvent from a tool for manufacturing a semiconductor device that includes a control box for receiving at least one input signal, including a front panel having a first indicator capable of providing an alert for chemical solvent leakage, and a circuit board for receiving the at least one input signal and triggering the alert, a tray configured for collecting the leaked chemical solvent, including a plurality of substantially vertical sides, and a plurality of legs, at least one of which being adjustable to render a corner of the tray closer to ground relative to other corners of the tray, and a sensor provided at a position relative to the tray for detecting chemical solvent leakage and providing the input signal to the control box

Also in accordance with the invention, there is provided a device for detecting leakage of a chemical solvent from a plurality of tools for manufacturing a semiconductor device that includes a control box for receiving a plurality of input signals having a front panel having a plurality of indicators, each capable of providing an alert for chemical solvent leakage, and a circuit board for receiving the plurality of input signals, determining an origin of the plurality of signals to correspond the received signal to one of the plurality of indicators, and triggering the alert. The device also includes at least one tray configured for collecting the leaked chemical solvent, including a plurality of legs, at least one of which being adjustable to render a corner of the tray closer to ground relative to other corners of the tray, and a plurality of sensors to monitor the plurality of tools, each of the sensors being provided at a position relative to the at least one tray for detecting chemical solvent leakage and providing the input signal to the control box.

In accordance with the invention, there is additionally provided a method for detecting leakage of a chemical solvent from at least one tool for manufacturing a semiconductor device that includes providing a control box for receiving an input signal indicating chemical solvent leakage, providing at least one of audio or visual alert upon receiving the input signal, providing an adjustable tray for collecting the leaked chemical solvent, providing a sensor to the tray at a position for detecting chemical solvent leakage, detecting chemical solvent leakage by the sensor; and providing the input signal by the sensor to the control box.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 is a prospective view of a control box consistent with one embodiment of the present invention;

FIG. 2A shows the back panel of the control box shown in FIG. 1;

FIG. 2B shows the front panel of the control box shown in FIG. 1;

FIG. 3 shows a circuit board consistent with one embodiment of the present invention;

FIG. 4 shows an apparatus consistent with one embodiment of the present invention; and

FIG. 5 shows an apparatus consistent with another embodiment of the present invention.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

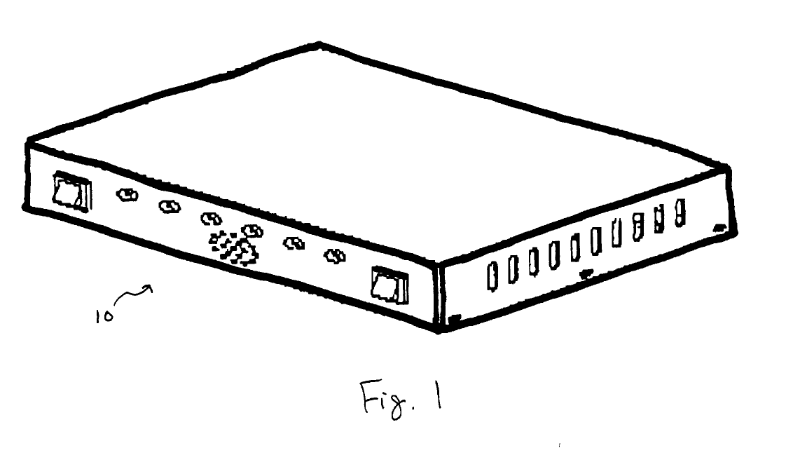

The present invention provides an apparatus and method for detecting liquid leakage and, more particularly, solvent leakage in a semiconductor manufacture tool, or equipment, that provides etching functions. The apparatus of the present invention generally includes a control box and a tray having a sensor. FIG. 1 is a prospective view of a control box 10 consistent with one embodiment of the present invention. Control box 10 is configured to receive a signal from the senor that indicates a solvent leakage event. The senor may transmit the signal indicating a solvent leakage event either through a signal line connecting the senor to control box 10, or through wireless applications. Either scheme may be provided through conventional signal processing mechanisms. Upon receiving a solvent leakage event signal, control box 10 may provide an audio alert, for example, through a built-in speaker (not shown), a visual alert, or both.

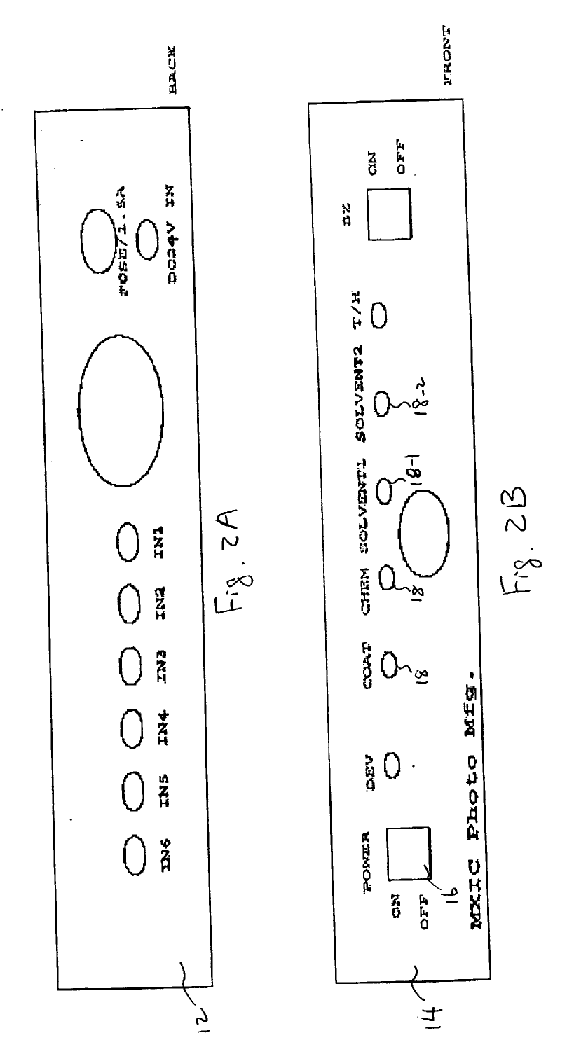

FIG. 2A shows a back panel 12 of control box 10. Referring to FIG. 2A, control box 10 is configured to accept a plurality of inputs, labeled IN1 . . . IN6, from a plurality of sensors, one coupled to a different semiconductor manufacture tool, when the sensors are coupled to control box 10 through signal lines. In wireless applications, inputs IN1 . . . IN6 may represent signal receivers that receive signals from the sensors. In other words, control box 10 is able to monitor a plurality of semiconductor manufacture tools simultaneously for solvent leakage.

FIG. 2B shows a front panel 14 of control box 10. Referring to FIG. 2B, front panel 14 includes a power switch 16, and a plurality of indicators 18. In one embodiment, indicators 18 are light-emitting diodes (“LEDs”). Each of the plurality of indicators 18 may indicate that a particular tool is being monitored by control box 10 and that there is no solvent leakage. For example, indicator 18-1 monitors a first semiconductor tool, designated as “Solvent 1” that uses a chemical solvent in the manufacturing process. Indicator 18-2 monitors a second semiconductor tool, designated as “Solvent 2” that uses a chemical solvent in the manufacturing process. When control box 10 receives a signal from a sensor indicating a solvent leakage event, appropriate indicator 18 may also provide a visual alert by, for example, displaying a red hue or a blinking red hue, together with an audio alert, to alert fab operators.

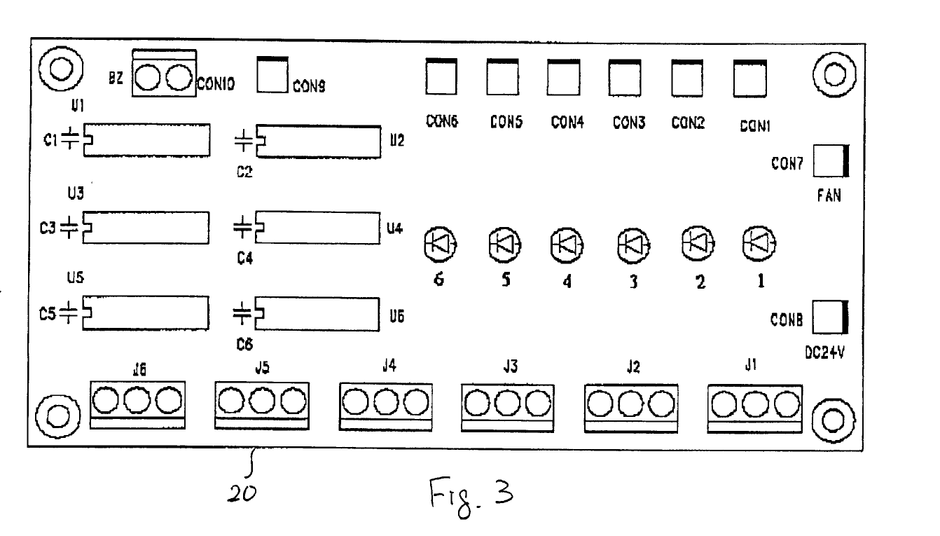

FIG. 3 shows a circuit board 20 provided in control box 10 consistent with one embodiment of the present invention. Circuit board 20 receives the signal from a sensor, and in the situation where control box 10 monitors more than one tool, determines the origin of the signal to correspond the received signal to one of indicators 18 and one of the monitored semiconductor manufacture tools. Circuit board 20 then processes the signal, and when appropriate, triggers the audio alert, visual alert, or both. Circuit board 20 may be implemented with conventional circuit designs.

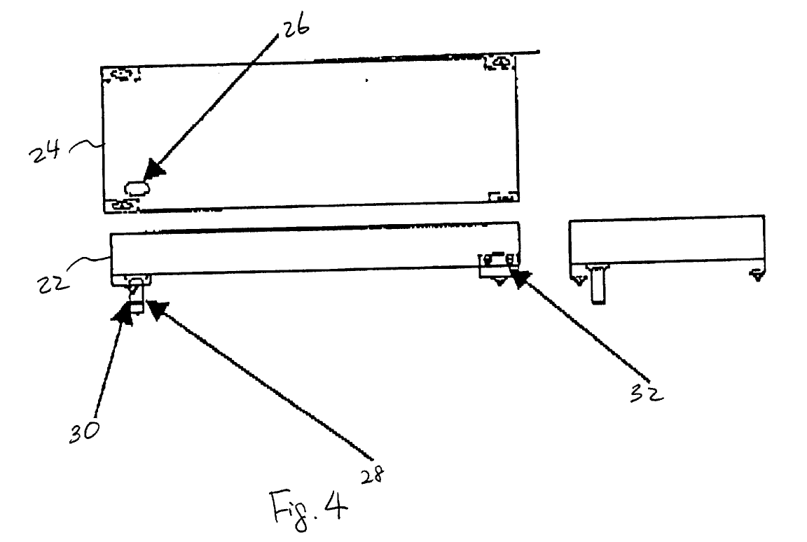

FIG. 4 shows a tray 22 consistent with one embodiment of the present invention. Referring to FIG. 4, tray 22 is provided underneath a semiconductor manufacture tool 24 that is used during wet etch processes. Semiconductor manufacture tool 24 generally includes a chamber (not shown) within which the etching processes occur, and a drain 26 from which a chemical solvent, in the event the solvent leaks out of the chamber, is leaked from semiconductor tool 24. Drain 26 may be provided by the manufacturer of semiconductor tool 24.

Tray 22 includes four substantially vertical sides (not numbered), a plurality of legs 32, at least one of which is adjustable, a sensor 28, and a tube 30. Tube 30 has a closed end and is provided at one of the four corners of tray 22. In one embodiment, tube 30 may be formed integral with tray 22. An opening (not shown) is provided directly above tube 30 so that any liquid collected inside tray 22 may be directed to the opening and down to tube 30. In one embodiment, tube 30 is made of a corrosive-resistant material, such as Teflon®. In another embodiment, tube 30 is transparent. Sensor 28 is provided at a position relative to tube 30 such that sensor 28 is able to detect when any liquid is collected inside tube 30. When any liquid, i.e., chemical solvent, is detected by sensor 28, sensor 28 transmits a signal to control box 10 to indicate a chemical solvent leakage event. In one embodiment, sensor 28 is attached to an L-shaped clip, which, in turn, is attached below tray 22.

The height of tray 22 is adjustable by the plurality of legs 32 such that the corner where tube 30 is located is at the lowest position relative to ground to direct to tube 30 any chemical solvent collected in tray 22. The chemical solvent is then detectable by sensor 28. Legs 32 are also adjustable to account for any uneven ground surface. The substantially vertical sides of tray 22 serve to contain any excess chemical solvent should the amount of solvent leakage exceed the capacity of tube 30. Tray 22 is made of a corrosive-resistant and leak-proof material to prevent further leakage of the chemical solvent collected therein.

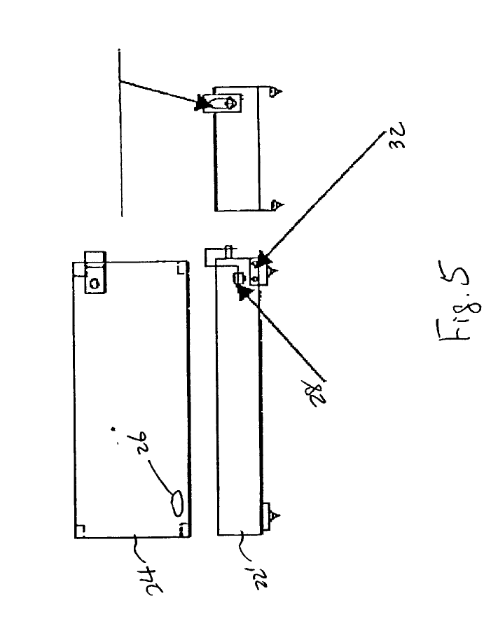

FIG. 5 shows an apparatus consistent with another embodiment of the present invention. Referring to FIG. 5, tray 22′ includes four substantially vertical sides (not numbered), a plurality of legs 32, at least one of which is adjustable, and a sensor 28. Sensor 28 is provided at a position relative to tray 22′ to detect when any liquid is collected in tray 22′. In one embodiment, sensor 28 is attached to an adjustable L-shaped clip (not numbered). Tray 22′ is adjustable by the plurality of legs 32. When any chemical solvent is detected by sensor 28, sensor 28 transmits a signal to control box 10 to indicate a chemical solvent leakage event.

Legs 32 are also adjustable to account for any uneven ground surface. The substantially vertical sides of tray 22′ serve to contain the chemical solvent.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A device for detecting leakage of a chemical solvent from a tool for manufacturing a semiconductor device, comprising:
a control box for receiving at least one input signal, including a front panel having a first indicator capable of providing an alert for chemical solvent leakage, and a circuit board for receiving the at least one input signal and triggering the alert;
a tray configured for collecting the leaked chemical solvent, including a plurality of substantially vertical sides, and a plurality of legs, at least one of which being adjustable to render a corner of the tray closer to ground relative to other corners of the tray; and
a sensor provided at a position relative to the tray for detecting chemical solvent leakage and providing the input signal to the control box.

2. The device as claimed in claim 1, wherein the tray further includes an opening and a tube, provided below the opening, for receiving any leaked chemical solvent.

3. The device as claimed in claim 2, wherein the tube is formed integral with the tray.

4. The device as claimed in claim 2, wherein the tube is made of a corrosive-resistant material.

5. The device as claimed in claim 2, wherein the tube is transparent.

6. The device as claimed in claim 1, wherein the sensor is attached to a clip attached to the tray.

7. The device as claimed in claim 6, wherein the clip is an L-shaped clip.

8. The device as claimed in claim 1, wherein the sensor is positioned below the tray.

9. A device for detecting leakage of a chemical solvent from a plurality of tools for manufacturing a semiconductor device, comprising:
a control box for receiving a plurality of input signals, including
a front panel having a plurality of indicators, each capable of providing an alert for chemical solvent leakage, and
a circuit board for receiving the plurality of input signals, determining an origin of the plurality of signals to correspond the received signal to one of the plurality of indicators, and triggering the alert;
at least one tray configured for collecting the leaked chemical solvent, including a plurality of legs, at least one of which being adjustable to render a corner of the tray closer to ground relative to other corners of the tray; and
a plurality of sensors to monitor the plurality of tools, each of the sensors being provided at a position relative to the at least one tray for detecting chemical solvent leakage and providing the input signal to the control box.

10. The device as claimed in claim 9, wherein the tray further includes an opening and a tube, provided below the opening, for receiving any leaked chemical solvent.

11. The device as claimed in claim 10, wherein the tube is formed integral with the tray.

12. The device as claimed in claim 10, wherein the tube is made of a corrosive-resistant material.

13. The device as claimed in claim 9, wherein the sensor is attached to a clip attached to the tray.

14. The device as claimed in claim 13, wherein the clip is an L-shaped clip.

15. The device as claimed in claim 9, wherein the tray is made of a corrosive-resistant and leak-proof material.

16. A method for detecting leakage of a chemical solvent from at least one tool for manufacturing a semiconductor device, comprising:
providing a control box for receiving an input signal indicating chemical solvent leakage;
providing at least one of audio or visual alert upon receiving the input signal;
providing an adjustable tray for collecting the leaked chemical solvent;
providing a sensor to the tray at a position for detecting chemical solvent leakage;
detecting chemical solvent leakage by the sensor; and
providing the input signal by the sensor to the control box.

17. The method as claimed in claim 16, further comprising providing a tube to the adjustable tray for receiving the leaked chemical solvent.
